(19) United States
(12) Patent Application Publication
(10) Pub. No.: US 2007/0168966 A1
(43) Pub. Date: Jul. 19, 2007

(54) Phased offloading of content information

(75) Inventors: Francesco Pessolano, Eindhoven (NL); Mauro Barbieri, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/572,620

(22) PCT Filed: Sep. 13, 2004
(86) PCT No.: PCT/IB04/51745

§ 371 Date: Mar. 17, 2006

(30) Foreign Application Priority Data
Sep. 22, 2003 (EP) 03103486.1

(51) Int. Cl. G06F 9/44

(52) U.S. Cl. 717/122

(57) ABSTRACT

A user of a mobile client requests electronic content information for being downloaded via a data network. The client first receives a semantically summarized version of the requested content information. If the downloading is prematurely interrupted, the user has at least a meaningful summary available.

### FIELD OF THE INVENTION

The invention relates to a method of offloading content information, to control software for controlling the offloading of content information, and to content information pre-processed for facilitating the offloading. The invention is in particular, but not exclusively, relevant to portable or mobile content storage devices, e.g., portable consumer electronics (CE) devices for storing and rendering the content stored thereon. The expression “content information” includes, e.g., one or more audio files, or one or more video files, or one or more still pictures, or one or more multimedia files, or a combination thereof, etc.

### BACKGROUND ART

A trend for the years to come is that the costs of data storage capacity per unit of data will decrease dramatically. At the same time, the size of a memory of a given storage capacity will continue to decrease owing to the technical developments. This applies especially to solid-state memories. These trends will go on to a point that solid-state memory is a cost-effective alternative to current hard-disk (HDD) based memory for inexpensive video/audio portable equipment. This means that large data storage is becoming available to portable devices such as cell phones, PDAs, music and video players, digital cameras and other personal CE devices. Accordingly, the user will get surrounded by a large decentralized or distributed memory encompassing, e.g., the home network, services on the Internet, portable equipment of a personal area network (PAN), etc. As this memory is distributed, data is exchanged between the various segments of the memory. For example, a mobile CE device will offload files from a stationary repository on the home network or from the Internet. The problem then arises of how to handle intentional or accidental interruption of the data exchange between the mobile device and the (stationary) repository or the access point.

This addresses the problem of data synchronization: the problem of how to maintain consistent with one another multiple data sets residing at different locations, e.g., different devices, different directories, etc. That is, how is all this memory to be synchronized in a fast and reliable manner that is tolerant of, e.g., a user, who does not want to wait for all selected data to download and terminates the process prematurely.

### SUMMARY OF THE INVENTION

To this end, the inventors propose a method of enabling to offload (e.g., download, upload) electronic content information from a server or a storage system. The method comprises first providing a summarized version of the content information. For example, the summarized version is offloaded before offloading the content information in its entirety. This requires the receiving end to store both summaries and full-length content information. As an alternative, the offloading of the content information comprises providing the complement to the summarized version upon having supplied the summarized versions in advance. In this manner, the complementing sections expand a summary cumulatively until the full-length, complete content information has been received.

The invention is relevant to the following example scenario. A user of a mobile client requests electronic content information for being downloaded via a data network. The client first receives a semantically summarized version of the requested content information. If the downloading is prematurely interrupted, the user has at least a meaningful summary available.

Methods for summarizing content information such as audio/video (AV) are extensively discussed in an overview “Video summarization: Methods and Landscape”, SPIE Sep. 7-11, 2003, Orlando Fla., by authors Mauro Barbieri, Lalitha Agnihotri and Nevenka Dimitrova, all with Philips Electronics Research.

More specifically, the invention relates to a method of providing electronic content information via a data network. The method comprises enabling to receive a semantically summarized version of the content information via the network upon a request for the content information. In an embodiment of the invention, the summarized version is provided before starting to provide the content information in its entirety. Optionally, the summarized version can be marked or otherwise be made available for (automatic) deletion after completion of the providing of the content information in its entirety. The party providing the complete content information and the party providing the summarized version can, but need not, be the same. As a supplemental service to the requesting customer, a service provider of full-length electronic content information may delegate the supply of summarized versions to another party. In another embodiment, the providing of the content information comprises supplying the complement to the summarized version after the summarized version has been provided. The combination of the summarized version and its complement form the complete content information.

An embodiment of the method according to the invention comprises retrieving the semantically summarized version from storage. The summarized version and the content information can be stored at the same server or may be stored at different network sites operated by the same or by different service providers. Alternatively, the semantically summarized version is generated upon receiving the request, e.g., on-the-fly. Again, the same server that supplies the content information may also supply the summary, but these services can be distributed between different network sites or servers as well. As to the option of generating summaries on-the-fly, reference is made to International Application WO0193091 (attorney docket US 000123), briefly discussed further below. The document relates to bookmarking or otherwise indicating segments of content information that are likely to be of more interest to an audience than other segments. Accordingly, an embodiment of a generator of on-the-fly summaries of content information, as proposed in the current invention, uses the marked segments only to generate an on-the-fly summary.

### BRIEF DESCRIPTION OF THE DRAWING

The invention is explained in further detail, by way of example and with reference to the accompanying drawing wherein:

FIGS. 1-3 are block diagrams of a system in the invention;

FIG. 4 is a diagram illustrating an embodiment of the invention.

Throughout the figures, same reference numerals indicate similar or corresponding features.

### DETAILED EMBODIMENTS

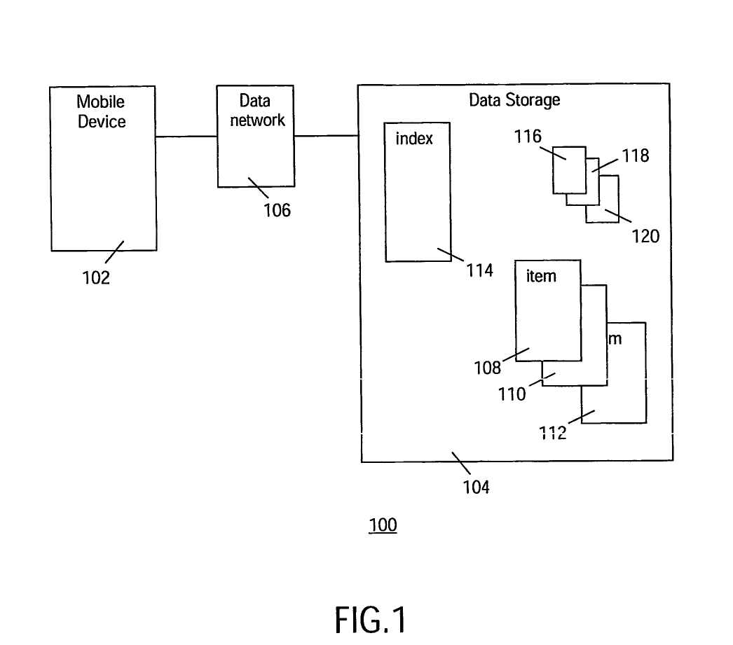

FIG. 1 is a block diagram of a system 100 in the invention. System 100 comprises a mobile device 102, data storage 104 and a data network 106 connecting device 102 and storage 104 for data communication. Storage 104 stores content information items 108, 110, . . . , 112. Content items 108-112 are individually selectable for being offloaded to device 102 via network 106. In order to select one or more specific ones of items 108-112 system 100 comprises an inventory, overview or index 114 of the items stored at storage 104. In this example, index 114 is accommodated at storage 104, but index 114 could have been stored at a suitable location elsewhere on system 100. Index 114 provides an overview of what content information is available to a user of device 102. The user selects for offloading one or more specific ones of items 108-112 through interaction with index 114 in a suitable manner.

For example, device 102 comprises a mobile MP3 player, and storage 104 is a stationary repository and stores mp3 files, e.g., organized in play-lists 108-112. Player 102 accesses storage 104 via network 106, that is, e.g., the Internet or the user's home network, via a suitable access point (not shown). As another example, device 102 comprises a mobile phone with video play-out and gaming facilities and with Internet access. Storage 104 comprises a server of a third party to which phone 102 has access via the Internet 106. Storage 104 provides video clips, movies and/or video games 108-112.

According to the invention, system 100 storage 104 also comprises summaries, or condensed versions, 116, 118, . . . , 120 of content items 108-112. For example, item 108 comprises a play-list of specific audio files, and the associated one of summaries 116-120 comprises a sub-set of the files of item 108, e.g., pre-selected according to a profile of the user or based on a user-history, or ranked by the user according to importance on a previous occasion. As another example, item 108 comprises a movie or another video file. The associated one of summaries 116-120 comprises only the highlights of this video. If the user of device 102 now accesses storage 104 and selects one or more of items 108-112, then first the corresponding ones of summaries 116-120 are being supplied to device 102 via network 106. After summaries 116-120 have been supplied, storage 104 supplies full copies of the selected ones of full-length items 108-112. Alternatively, storage 104 supplies for each selected one of items 108-112 the complement with respect to the corresponding summary already provided. That is, storage 104 communicates the selected one of items 108-112, minus the content portion contained in the associated one of summaries 116-120 as the latter has already been sent.

A user of device 102 may have subscribed to the service provided by storage 104 in order to be able to offload items 108-112 and be charged a basic fee, e.g., as in any conventional video-on-demand or music-on-demand system. For an additional fee, the service carries out the method of the invention by providing the relevant summary/summaries prior to downloading the full-length content.

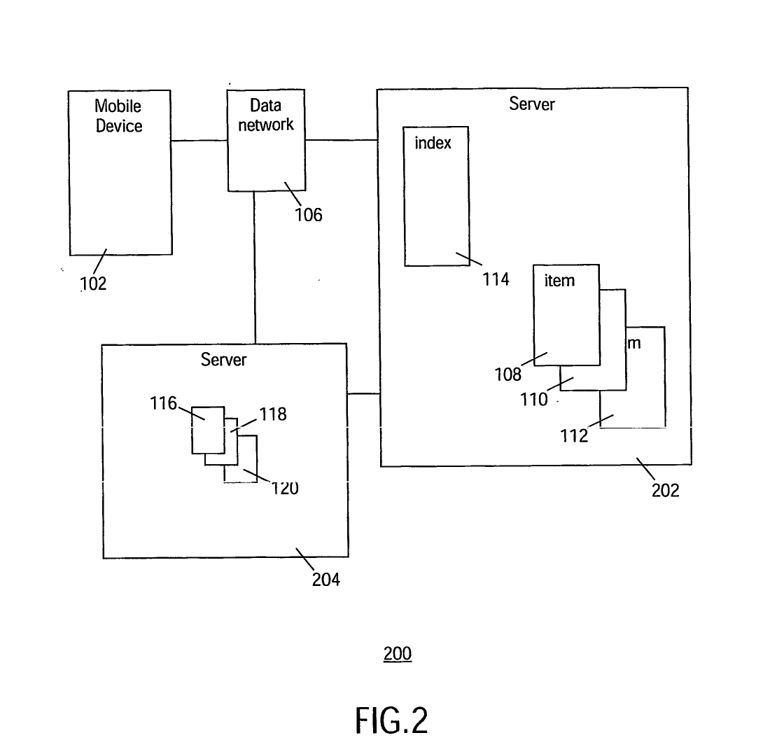

FIG. 2 is a block diagram of a system 200 as an alternative to system 100. In FIG. 1, summaries 116-120 are provided by the same storage 104 (or server in this case) as that provides full-length items 108-112. In system 200 the storage of items 108-112 is implemented on a first server 202 and the storage of summaries 116-120 is implemented on a second server 204. When the user of device 102 requests a download of file 108 from server 202, he/she first get connected to server 204 in order to obtain the relevant one of summaries 116-120. For example, server 204 is an edge server or caching server on the Internet 106 in the geographic neighborhood of device 102. The geographic position of device 102, if it is a mobile device, can be determined via the network address of the access point (not shown) used. In this manner, the summaries are loaded from a server fewer hops away than main server 202, thus supporting a fast and robust data connection at least for summaries 116-120. The configuration of system 200 can be employed by a party to provide an optional service to the user of device 102 in order to enhance the service supplied by the party of server 202. As already mentioned above, creating summaries may be done manually by a professional editor, which can be rather time consuming and therefore expensive. As an alternative, algorithms have become available to automatically create summaries of, e.g., video. In case of, e.g., the user's audio play-lists, the user him/herself may rank the songs of the play-list in advance according to importance or personal preference so as to have the more important songs offloaded first.

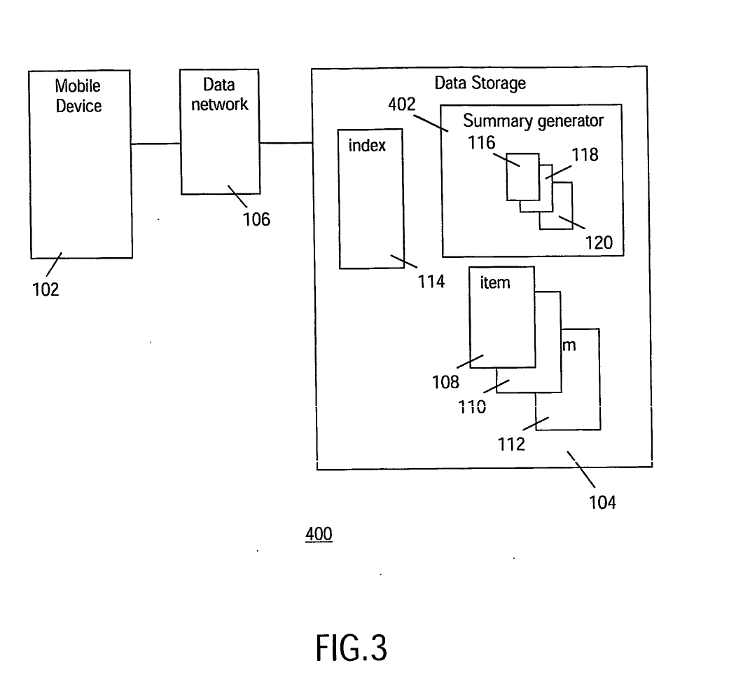

In the scenarios discussed above, summaries have been created in advance and are stored on the system in order for being retrieved in the phased offloading of content information: summaries first, entire content or the complement to the summaries later on. FIG. 3 is a block diagram of a system 400 providing an alternative. System 400 comprises a summary generator 402 that generates summaries 116-118 on-the-fly, i.e., upon receipt of a request from device 102 for items 108-112. That is, summaries 116-120 are not necessarily stored in advance. Summaries 116-120 can get cached, for example, in anticipation of a growing demand.

Further to systems 100, 200 and 400, server or storage 104, communicating with device 102 via data network 106, is preferably capable of generating different versions of a particular summary depending on, for example, the connection bandwidth (e.g., a high-quality video summary for fast connection to a portable DVD player and a lower-quality summary for a slow connection to a mobile phone), subscription fee or user-preferences. Within this context, reference is made to U.S. Pat. No. 6,076,166 (attorney docket PHA 23,217), briefly discussed further below.

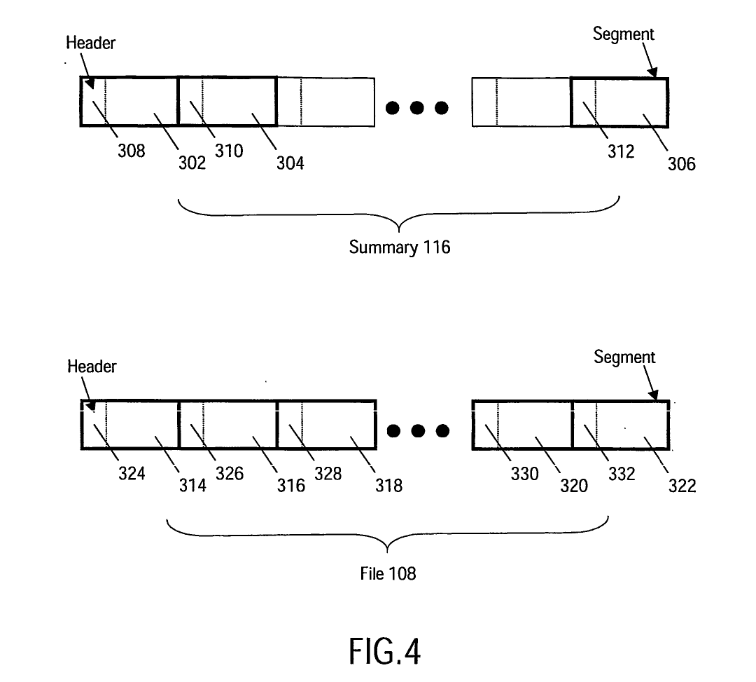

FIG. 4 is a diagram illustrating an embodiment of the offloading process in the invention. Consider the example wherein device 102 receives summary 116 associated with file 108. Summary 116 is comprised of multiple segments 302, 304, . . . , 306. Each of segments 302-306 has a respective header 308, 310, . . . , 312 that contains a respective indication of the order wherein segments 302-306 are to be played out. File 108 is comprised of a plurality of segments 314, 316, 318, . . . , 320, 322 as well, preferably with each thereof comprising a respective header 324, 326, . . . , 332 with an indication of the order wherein segments 314-322 are to be rendered. Preferably, the indication of segments 302-306 enables to determine their ranking relative to the play-out order of segments 314-322. This then allows summary 116 being offloaded first in terms of segments 302-306, and then their complement in file 108, e.g., segments 318 and 320. Together segments 302-306,318 and 320 form the complete, or substantially complete, semantic content of file 108, wherein their respective headers enable to determine the correct order of play-out.

The invention is relevant to, e.g., movie libraries/services and music libraries/services on the Internet, news agencies on the Internet, etc.

The invention has been illustrated above with a mobile device getting content offloaded from a server or storage. For mobile devices the advantages of the sketched approaches are clear. It is to be understood that the invention is not restricted to mobile devices or clients. Devices or clients, other than mobile ones, can benefit from the invention as well.

### INCORPORATED HEREIN BY REFERENCE

U.S. Ser. No. 09/971,474 (attorney docket US 018166) filed Oct. 4, 2001 for Eugene Shteyn and Jean Moonen for DIGITAL CONTENT CATERING SERVICE, published as U.S. patent application publication no. 20030069964. This document relates to the catering of electronic content information via a network. A consumer is enabled to request delivery via the network of a specific piece of content before a deadline selectable by the consumer. The catering service then completes the delivery before the deadline under control of a bandwidth profile of data traffic on at least a segment of the network. The scheduling of delivery deadline enables the service to optimize usage of the network's bandwidth while maintaining a quality of service.
U.S. Pat. No. 6,128,021 (attorney docket PHA 23,162) issued to Pieter van der Meulen and Greg Roelofs for DOWNLOADING IMAGE GRAPHICS WITH ACCELERATED TEXT CHARACTER AND LINE ART CREATION. This patent relates to transferring an image from a sender to a receiver. The image is progressively re-created at a display of the receiver. First, a low-resolution full-color representation of the image is transferred. Then, a full-resolution limited-color representation of the image is sent. The pixel values of the full-resolution representation typically represent alpha-numerical characters or edges of features. The representations are combined to create a version of the image by modifying the pixels of first representation under control of the limited-color content of the spatially corresponding pixel of the second representation. The legibility of the combined image is achieved considerably faster than with conventional techniques.
U.S. Pat. No. 6,076,166 (attorney docket PHA 23,217) issued to Mehran Moshfeghi et al., for A METHOD FOR PERSONALIZING HOSPITAL INTRANET WEB SITES. This patent relates to a client-server system. The server includes a layer for dynamically generating web pages and other data objects using scripts, such as graphic, audio and video files, in dependence on stored information indicating the user's needs and preferences, including those presumed from stored information as to the user's function, job, or purpose for being at the hospital, and logged usage profiles, the level of the user's access privileges to confidential patient information, and the computer and physical environments of the user. Notably, the content is generated in dependence on the display resolution and lowest bandwidth link between the server and browser to limit the waiting time for downloads as well as the server load.
U.S. Ser. No. 09/585,825 (attorney docket US 000123) filed Jun. 1, 2000, for Eugene Shteyn for CONTENT WITH BOOKMARKS OBTAINED FROM AN AUDIENCE'S APPRECIATION, published as International Application WO0193091. This document relates to a method of providing bookmarks for indicating elements or portions of content information that are likely to be of great interest to an audience. A broadcast station can make these bookmarks available for sale or lease to a third party for inserting data into the content information at the bookmarked locations. The third party can insert advertisements in the information content close to the indicated portions that the audience is likely to appreciate.

1. A method of providing electronic content information via a data network, the method comprising enabling to receive a semantically summarized version of the content information via the network upon a request for the content information.

2. The method of claim 1, wherein the summarized version is provided before starting to provide the content information in its entirety.

3. The method of claim 1, wherein the providing of the content information comprises supplying the complement to the summarized version after the summarized version has been provided.

4. The method of claim 2, comprising making the summarized version available for deletion after completion of the providing of the content information in its entirety.

5. The method of claim 1, comprising retrieving the semantically summarized version from storage.

6. The method of claim 5, wherein the summarized version and the content information are stored at different network sites.

7. The method of claim 1, comprising generating the semantically summarized version upon the request.

8. The method of claim 7, wherein the generating of the summarized version and the providing of the content information are carried out at different network locations.

9. Control software for installing on a home network, the control software being operative to first download to a device a summarized version of electronic content information upon a request for the electronic content information.

10. Control software for being installed on a data network for control of providing electronic content information via the data network, the control software being operative to enable to receive a semantically summarized version of the content information via the network upon a request for the content information.

11. An apparatus for receiving electronic content information from a server via a data network, the apparatus enabled to receive a semantically summarized version of the content information via the network upon a request for the content information.
